(19) United States
(12) Patent Application Publication
(10) Pub. No.: US 2009/0262625 A1
(43) Pub. Date: Oct. 22, 2009

(54) OPTICAL DISK DEVICE

(76) Inventors: Shinya Asano, Tokyo (JP); Nozomu Harada, Kawasaki (JP); Seiji Hamaie, Kawasaki (JP)

Correspondence Address: MCDERMOTT WILL & EMERY LLP, 600 13TH STREET, N.W., WASHINGTON, DC, 20005-3096, US

(21) Appl. No.: 12/423,268

(22) Filed: Apr. 14, 2009

(30) Foreign Application Priority Data
Apr. 18, 2008 (JP) JP 2008-108909

(51) Int. Cl. G11B 7/00

(52) U.S. Cl. 369/100; G9B/7

(57) ABSTRACT

An optical disk device is provided to carry out a stable operation of a reflection-type photo sensor which detects a position of an optical pickup unit and to simplify an assembly process. The optical disk device includes: a chassis; an optical pickup unit which is disposed in the chassis and is moved in a radial direction of the mounted optical disk so as to carry out at least one of recording and reproducing of a signal on the information recording surface of the optical disk; a reflection-type photo sensor which is disposed in the chassis and includes a light-emitting unit and a light-receiving unit; a reflection unit which is disposed in the optical pickup unit and reflects light emitted from the light-emitting unit according to movement of the optical pickup unit so as to be incident on the light-receiving unit; and a black member which is disposed at a position facing the reflection-type photo sensor of the chassis, wherein the chassis is provided with a mold portion which is formed by mold forming, and wherein the black member is integrally formed with the mold portion.

### INCORPORATION BY REFERENCE

The present application claims priority from Japanese application JP2008-108909 filed on Apr. 18, 2008, the content of which is hereby incorporated by reference into this application.

### FIELD OF THE INVENTION

The present invention relates to an optical disk device which carries out at least one of recording and reproducing of signals on an information recording surface of a mounted optical disk.

### DESCRIPTION OF RELATED ART

Conventionally, an optical disk device, which is suitably used for a stationary electronic apparatus such as a personal computer and a portable electronic apparatus such as a notebook computer, a portable information terminal and a portable video apparatus, includes a turn table on which the optical disk is mounted. Further, the optical disk device includes a motor for rotationally driving the mounted optical disk, an optical pickup unit which moves in a radial direction of the mounted optical disk and carries out at least one of recording and reproducing of the signals on the information recording surface of the optical disk, and an optical pickup unit moving device for moving the optical pickup unit. Concerning such an optical disk device, various methods of detecting a position of the moved optical pickup unit have been proposed.

For example, there is proposed an optical disk device which includes: a reflection-type photo sensor which is provided in a mechanical chassis, and a reflection mechanism which is provided in an optical pickup unit, wherein the reflection photo sensor is configured such that a light-emitting element and a light-receiving element are arranged in a tabular shape, and wherein when the optical pickup unit is positioned at the innermost peripheral position of the optical disk, output light of the light-emitting element is reflected by the reflection mechanism to be incident on the light-receiving element. Therefore, it is possible to detect the optical pickup unit on the innermost peripheral position of the optical disk (for example, refer to JP-A-2000-67437).

As described in JP-A-2000-67437, when the reflected light by the reflection mechanism provided in the optical pickup unit is detected by the reflection-type photo sensor which is provided in the mechanical chassis, there is a need for definitely distinguishing between light and shade for stabilization of operations. Therefore, there is designed that a sheet of black color (black sheet) is attached at a position facing the reflection-type photo sensor of the mechanical chassis.

However, working for attaching the black sheet on a predetermined position of the mechanical chassis is cumbersome and positioning of the black sheet is difficult. In addition, there is some fear that the black sheet is gradually separated from the mechanical chassis over time, the predetermined position thereof is shifted or the like.

### BRIEF SUMMARY OF THE INVENTION

In a view of the above circumstances, an object of the present invention is to provide an optical disk device, which can carry out stable operations of a reflection-type photo sensor for detecting a position of an optical pickup unit and simplify an assembly process.

In order to achieve the above object of the present invention, there is provided an optical disk device which carries out at least one of recording and reproducing of a signal on an information recording surface of a mounted optical disk, including: a chassis; an optical pickup unit which is disposed in the chassis and moves in a radial direction of the mounted optical disk so as to carry out at least one of recording and reproducing of a signal on the information recording surface of the optical disk; a reflection-type photo sensor which is disposed in the chassis and includes a light-emitting unit and a light-receiving unit; a reflection unit which is disposed in the optical pickup unit and reflects light emitted from the light-emitting unit according to movement of the optical pickup unit so as to be incident on the light-receiving unit; and a black member which is disposed at a position facing the reflection-type photo sensor in the chassis, wherein the chassis is provided with a mold portion which is formed by a mold forming, and wherein the black member is integrally formed with the mold portion.

According to the optical disk device of the present invention, it is possible to carry out stable operations of the reflection-type photo sensor for detecting a position of the optical pickup unit, and an assembly process can be simplified.

Other objects, features and advantages of the invention will become apparent from the following description of the embodiments of the invention taken in conjunction with the accompanying drawings.

### BRIEF DESCRIPTION OF SEVERAL VIEWS OF DRAWING

FIG. 1 is a perspective view illustrating a state where a unit cover is removed from a unit mechanism which is provided in a housing of an optical disk device according to an embodiment of the present invention, in which an optical pickup unit is moved to an outermost peripheral position of a mounted optical disk.

FIG. 2 is a perspective view illustrating a state where the optical pickup unit is moved to an innermost peripheral position of the mounted optical disk in the unit mechanism shown in FIG. 1.

FIG. 3 is a perspective view illustrating the unit mechanism shown in FIG. 1 viewed in a different direction.

FIG. 4 is a perspective view illustrating a guide shaft holding member which is a constituent element of the unit mechanism shown in FIG. 1.

FIG. 5 is a view schematically illustrating a vicinity of a reflection-type photo sensor which is a constituent element of the unit mechanism shown in FIG. 1, in which the reflection-type photo sensor is in an OFF state.

FIG. 6 is a view schematically illustrating a vicinity of the reflection-type photo sensor which is a constituent element of the unit mechanism shown in FIG. 1, in which the reflection-type photo sensor is in an ON state.

FIG. 7 is a perspective view illustrating a unit mechanism according to another embodiment of the present invention.

FIG. 8 is a perspective view illustrating a unit mechanism according to another embodiment of the present invention.

### DETAILED DESCRIPTION OF THE INVENTION

Next, the optical disk device according to a preferred embodiment of the present invention will be described with reference to the accompanying drawings. In addition, the embodiments to be described below are only examples in order to describe the present invention, and the present invention is not limited thereto. Therefore, various modifications can be made without swerving from the spirit of the present invention.

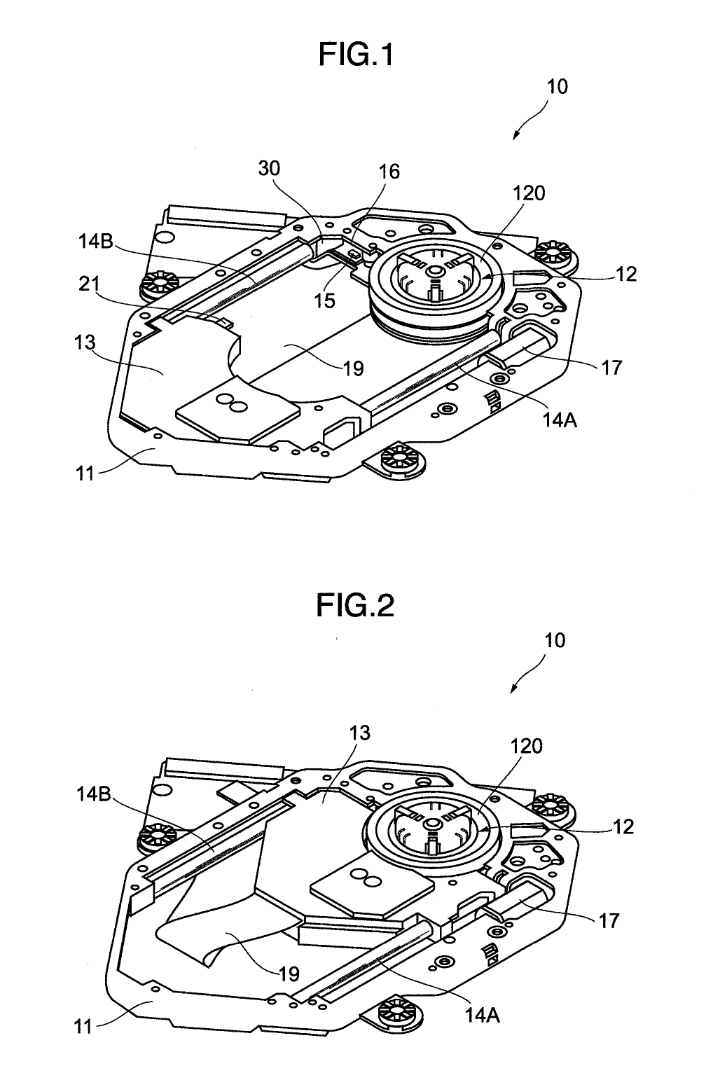

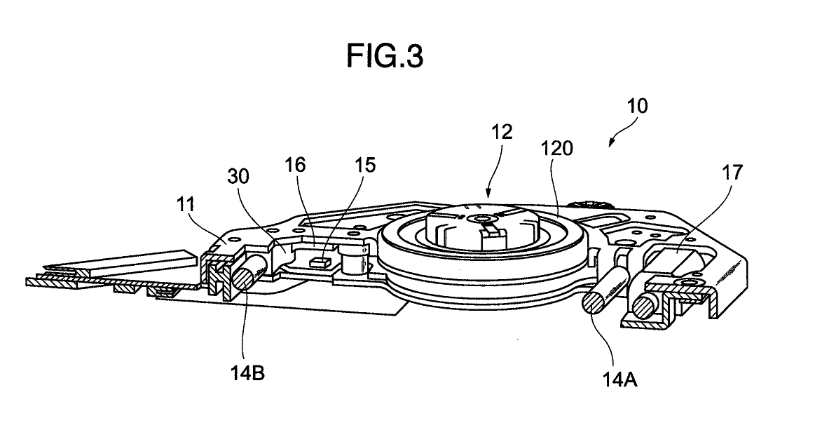

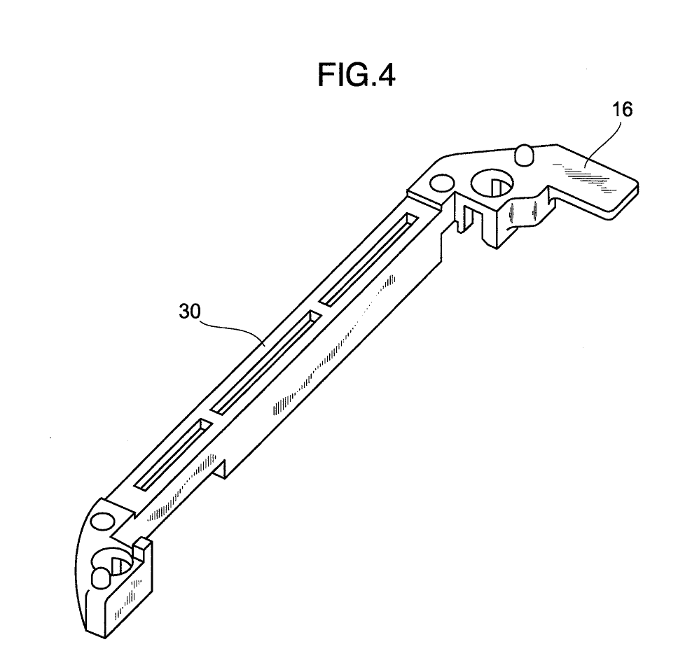

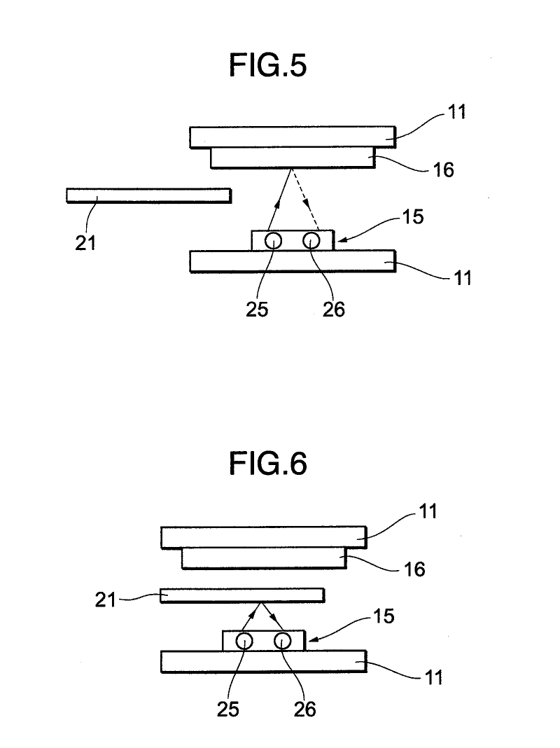

FIG. 1 is a perspective view illustrating a state where a unit cover is removed from a unit mechanism which is provided in a housing of an optical disk device according to an embodiment of the present invention, in which an optical pickup unit is moved to the outermost peripheral position of a mounted optical disk. FIG. 2 is a perspective view illustrating a state where the optical pickup unit is moved to the innermost peripheral position of the mounted optical disk in the unit mechanism shown in FIG. 1. FIG. 3 is a perspective view illustrating the unit mechanism shown in FIG. 1 viewed in a different direction. FIG. 4 is a perspective view illustrating a guide shaft holding member which is a constituent element of the unit mechanism shown in FIG. 1. FIG. 5 is a view schematically illustrating a vicinity of a reflection-type photo sensor which is a constituent element of the unit mechanism shown in FIG. 1, in which the reflection-type photo sensor is in an OFF state. FIG. 6 is a view schematically illustrating a vicinity of a reflection-type photo sensor which is a constituent element of the unit mechanism shown in FIG. 1, in which the reflection-type photo sensor is in an ON state. In addition, for convenience of explanation, thicknesses and sizes, an extension rate or a reduction rate of each member in the drawings are described different from actual dimensions.

As shown in FIGS. 1 to 3, the unit mechanism 10 is provided in the housing of the optical disk device according to the present embodiment, and includes a chassis 11 forming a framework which is occupying the peripheral portion. The chassis 11 includes a spindle motor 12 for rotationally driving the mounted optical disk, an optical pickup unit 13 which is disposed to face an information recording surface of the optical disk and carries out recording and/or reproducing of the signals, guide shafts 14A and 14B which support the optical pickup unit 13 and guide the optical pickup unit 13 to move, a reflection-type photo sensor 15 which is disposed in the chassis 11 and detects a position of the optical pickup unit 13, and a black member 16 which is disposed at a position facing the reflection-type photo sensor 15 in the chassis 11.

The optical disk device according to the present embodiment may be adopted with a slot system in which the optical disk is inserted into or discharged from a front surface of the housing, and the optical disk is automatically transported to be attached to or detached from the optical disk device between the front surface and the unit mechanism 10 by using a mechanism provided in the optical disk device. Further, the optical disk device may be adopted with a tray system in which a tray protrudes to the front of the housing in a state where the unit mechanism 10 is fixed in the system when the optical disk is attached to or detached from the optical disk device. In addition, the optical disk device may be adopted with an upper part opening and closing system in which the optical disk is attached to or detached from the optical disk device by opening or closing an upper cover of the housing.

On the upper portion of the spindle motor 12, a turn table 120 is provided to chuck the optical disk mounted on the outer periphery thereof.

The optical pickup unit 13 is provided with, for example, a laser diode, a laser driving IC, and the like, for carrying out recording and/or reproducing of information of the optical disk which is mounted on the turn table 120. Both sides of the optical pickup unit 13 are movably supported on a guide shaft 14A, which is disposed in the chassis 11 and serves as a main shaft, and a guide shaft 14B which serves as a sub-shaft, respectively. In addition, the optical pickup unit 13 is connected to an optical pickup driving device 17 which is disposed in the vicinity of the tip portion (on a side of the spindle motor 12) at a rear side of the guide shaft 14A in the chassis 11. Therefore, a driving force from the optical pickup driving device 17 is transferred to the optical pickup unit 13 so as to be moved in the radial direction of the optical disk along the guide shafts 14A and 14B. In addition, the guide shaft 14B is held by a guide shaft holding member 30 which is disposed in the chassis 11.

At the tip which is on a side of the guide shaft 14B of the optical pickup unit 13 and on a side of the spindle motor 12, a reflection plate 21 is disposed, which reflects light irradiated from a reflection-type photo sensor 15 to be described later. For example, the reflection plate 21 may be made of a metal, and be designed to be positioned between the reflection-type photo sensor 15 and the black member 16, as shown in FIG. 6, when the optical pickup unit 13 is moved to the innermost peripheral position of the optical disk which is mounted on the turn table 120 as shown in FIG. 2.

In addition, at the end portion of the optical pickup unit 13 where the spindle motor 12 is separated, a flexible cable (FPC) 19 is extended so as to connect the optical pickup unit 13 with a circuit substrate (not shown) which is disposed in the housing of the optical disk device.

The reflection-type photo sensor 15 serves as a position detecting switch for detecting the position of the optical pickup unit 13. As shown in FIGS. 5 and 6, the reflection-type photo sensor 15 includes an LED 25 serving as a light-emitting unit (light-emitting element) and a photo diode 26 serving as a light-receiving unit (light-receiving element). The reflection-type photo sensor 15 is disposed at a position in the chassis 11 facing the reflection plate 21 when the optical pickup unit 13 is moved to the innermost peripheral position of the optical disk. As shown in FIG. 2, when the optical pickup unit 13 is moved to the innermost peripheral position of the optical disk, the LED 25 emits light, and the light reaches the reflection plate 21 to be reflected by the reflection plate 21. Then, the light is incident on the photo diode 26 (refer to FIG. 6). By such an operation, the reflection-type photo sensor 15 (position detecting switch) becomes the ON state, for example. On the other hand, as shown in FIG. 1, when the optical pickup unit 13 is moved from the innermost peripheral position to the outermost peripheral position of the optical disk, the light emitted from the LED 25 is incident on the black member 16 to be described later. An amount of the light incident on the photo diode 26 is to be less than that in the ON state (refer to FIG. 5). By such an operation, the reflection-type photo sensor 15 (position detecting switch) becomes the OFF state, for example.

In addition, at the position facing the reflection-type photo sensor 15, the black member 16 is disposed so as to be separated from the reflection-type photo sensor 15 by a predetermined gap. The black member 16 is integrally formed on the tip of the guide shaft holding member 30 at the side of the spindle motor 12. Further, when the guide shaft holding member 30 is disposed in the chassis 11, the black member 16 is designed to be disposed at a position facing the reflection-type photo sensor 15. Specifically, the black member 16 is continuously formed on the guide shaft holding member 30 in a state of being bent in a direction substantially perpendicular to a longitudinal direction (in which the optical pickup unit 13 is moved) of the guide shaft holding member 30. As shown in FIG. 4, the guide shaft holding member 30 and the black member 16 are formed in a substantial L shape in plan view. In addition, the guide shaft holding member 30 and the black member 16 are integrally formed by being molded with a black resin.

With the configuration, by disposing the guide shaft holding member 30 in the chassis 11, the black member 16 can be disposed at a position facing the reflection-type photo sensor 15 of the chassis 11 (or facing the reflection plate 21 when the optical pickup unit 13 is moved to the innermost peripheral position), instead of carrying out an additional process such as attaching the black member 16 to a predetermined position of the chassis 11 as the conventional configuration. Therefore, it is possible to simply carry out the positioning, and the assembly process can be simplified. In addition, the number of components can be reduced, and a defect such as forgetting the black member 16 to dispose in the chassis or the like can be suppressed.

Here, a distance between the reflection-type photo sensor 15 and the black member 16 is one of factors for achieving stabilization in operation of the reflection-type photo sensor 15, and the distance can be selected in accordance with characteristics of the peripheral components. However, since the black member 16 is formed by being molded, the thickness of the black member 16 can be changed in manufacturing. Therefore, the distance between the reflection-type photo sensor 15 and the black member 16 can be easily changed, and the stabilization in operation of the reflection-type photo sensor 15 can be achieved.

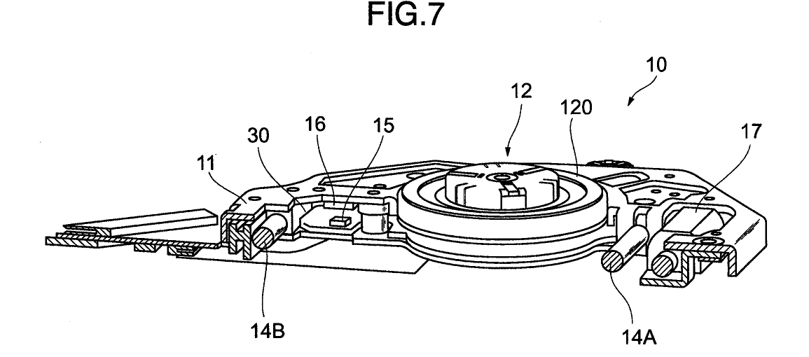

In addition, in the present embodiment, the case where the black member 16 is integrally formed on the tip of the guide shaft holding member 30 has been described. However, the present invention is not limited thereto, and the black member 16 may be formed together with the chassis 11 by being molded of black resin, and thereby being disposed at a position facing the reflection type photo sensor 15, for example. Specifically, as shown in FIG. 7, when the chassis 11 is formed by being molded, the black member 16 may be integrally formed at a position of the chassis 11 facing the reflection plate 21 when the optical pickup unit 13 is moved to the innermost peripheral position of the optical disk. According to such a configuration, only by just carrying out the mold forming by the use of a mold which can form the black member 16 at a predetermined position of the chassis 11, it is possible to dispose the black member 16 at the predetermined position in the chassis 11. Therefore, it is possible to simply position the black member 16 without carrying out an additional process such as attaching the black member 16 to a predetermined position of the chassis 11 as the conventional configuration, and the assembly process can be simplified. In addition, the number of components can be reduced, and a defect such as forgetting the black member 16 to dispose in the chassis or the like can be suppressed.

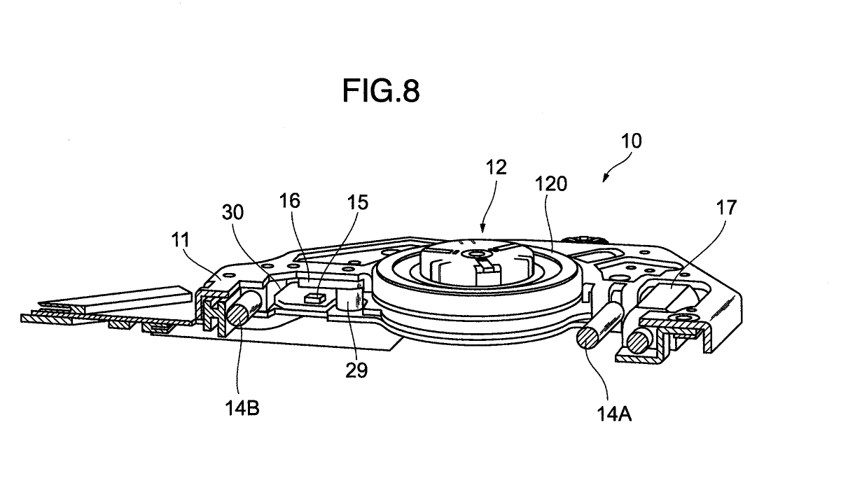

In addition, for example, the black member 16 may be disposed at a position facing the reflection-type photo sensor 15 by being molded with fixing members (for example, screw and caulk, etc.) which fixes components to the chassis 11 and the black resin. Specifically, as shown in FIG. 8, for example, the black member 16 may be integrally formed with a fixing member 29 for fixing the spindle motor 12 to the chassis 11 and disposed at a position facing the reflection-type photo sensor 15 when the spindle motor 12 is fixed to the chassis 11 by the fixing member 29. According to such a configuration, only by just carrying out the mold forming by the use of a mold which can form the black member 16 at a predetermined position in the fixing member 29, the black member 16 can be formed on the fixing member 29. Further, by carrying out the normal process which fixes the components on the chassis 11, the black member 16 can be disposed on a predetermined position. Therefore, it is possible to simply position the black member 16 without carrying out an additional process such as attaching the black member 16 to a predetermined position of the chassis 11 as the conventional configuration, and the assembly process can be simplified. In addition, the number of components can be reduced, and a defect such as forgetting the black member 16 to dispose in the chassis or the like can be suppressed.

It should be further understood by those skilled in the art that although the foregoing description has been made on embodiments of the invention, the invention is not limited thereto and various changes and modifications may be made without departing from the spirit of the invention and the scope of the appended claims.

1. An optical disk device which carries out at least one of recording and reproducing of a signal on an information recording surface of a mounted optical disk, comprising:
a chassis;
an optical pickup unit which is disposed in the chassis and is moved in a radial direction of the mounted optical disk so as to carry out at least one of recording and reproducing of a signal on the information recording surface of the optical disk;
a reflection-type photo sensor which is disposed in the chassis and includes a light-emitting unit and a light-receiving unit;
a reflection unit which is disposed in the optical pickup unit and reflects light emitted from the light-emitting unit according to movement of the optical pickup unit so as to be incident on the light-receiving unit; and
a black member which is disposed at a position facing the reflection-type photo sensor in the chassis,
wherein said chassis is provided with a mold portion which is formed by a mold forming, and
wherein said black member is integrally formed with said mold portion.

2. The optical disk device according to claim 1, further comprising a guide shaft which is disposed in said chassis and guides said movement of said optical pickup unit while supporting the optical pickup unit,
wherein said mold portion is a guide shaft holding member for holding said guide shaft.

3. The optical disk device according to claim 1,
wherein said mold portion is a fixing member for fixing a component on said chassis.

4. The optical disk device according to claim 1,
wherein said chassis is formed by a mold forming and is integrally formed with said mold portion.

5. The optical disk device according to claim 2,
wherein said chassis is formed by a mold forming and is integrally formed with said mold portion.
